(19) United States
(12) Patent Application Publication
(10) Pub. No.: US 2006/0214664 A1
(43) Pub. Date: Sep. 28, 2006

(54) OBM sensor with a loop antenna

(75) Inventors: Martin Folberth, Hannover (DE); Christian Fulda, Sehnde (DE); Matthias Gorek, Hannover (DE)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/088,443

(22) Filed: Mar. 24, 2005

(51) Int. Cl. G01V 3/08

(52) U.S. Cl. 324/339

(57) ABSTRACT

A method and apparatus for downhole resistivity imaging uses an antenna coupled to a power source through a directional coupler. Measured reflectivity values are indicative of the antenna impedance and the formation resistivity, particularly if some compensation is made for the antenna inductance.

### BACKGROUND OF THE INVENTION

1. Field of the Invention

The present invention relates to well logging. In particular, the present invention is an apparatus and method for imaging of subsurface formations using electrical methods.

2. Description of the Related Art

U.S. Pat. No. 4,468,623, issued to Gianzero, discloses tool mounted pads, each with a plurality of small measure electrodes from which individually measurable survey currents are injected toward the wall of the borehole. The measure electrodes are arranged in an array in which the measure electrodes are so placed at intervals along at least a circumferential direction (about the borehole axis) as to inject survey currents into the borehole wall segments which overlap with each other to a predetermined extent as the tool is moved along the borehole. The measure electrodes are made small to enable a detailed electrical investigation over a circumferentially contiguous segment of the borehole so as to obtain indications of the stratigraphy of the formation near the borehole wall as well as fractures and their orientations. In one technique, a spatially closed loop array of measure electrodes is provided around a central electrode with the array used to detect the spatial pattern of electrical energy injected by the central electrode. In another embodiment, a linear array of measure electrodes is provided to inject a flow of current into the formation over a circumferentially effectively contiguous segment of the borehole. Discrete portions of the flow of current are separably measurable so as to obtain a plurality of survey signals representative of the current density from the array and from which a detailed electrical picture of a circumferentially continuous segment of the borehole wall can be derived as the tool is moved along the borehole. In another form of an array of measure electrodes, they are arranged in a closed loop, such as a circle, to enable direct measurements of orientations of resistivity of anomalies.

The device of Gianzero '623, is primarily designed for highly conductive mud. In oil based muds, (OBM) the currents flowing from the electrodes depend upon good contact between the electrode and the borehole wall. If the borehole wall is irregular, the contact and the current from the electrodes is irregular, resulting in inaccurate imaging of the borehole. Finally, being a wireline tool, a plurality of contact pads disposed around the logging tool must be used to get a 360° scan of the borehole.

OBM increase drilling efficiency due to better lubrication of drill bits. In addition, an increasing number of present day exploration prospects lie beneath salt layers that are water soluble, necessitating the use of OBM for drilling

U.S. Pat. No. 3,973,181 to Calvert teaches a method and apparatus for investigating earth formations traversed by the borehole containing an electrically nonconductive fluid in which a system of pad-mounted electrodes are arranged laterally around a well tool. A high frequency oscillator is coupled to the electrodes through a selectively variable capacitor. As the apparatus is passed through the borehole, the high frequency current produced by the oscillator capacitively couples the electrodes to the formation and provides a measure of the electrical conductivity or resistivity of the earth formation.

U.S. Pat. No. 4,052,662 to Rau et al. discloses a wireline resistivity measuring device that preferably operates in the frequency range of 300 MHz to 300 GHz. In order to make accurate phase measurements at such high frequencies, a heterodyning principle is used with the received signals being mixed with an oscillator that has an output frequency that differs from the frequency of the transmitted signal: the difference may be 100 kHz or so. The addition of a mixer and the secondary oscillator, adds greatly to the complexity of the hardware. Such heterodyning has commonly been used in high frequency resistivity measuring devices.

U.S. Pat. No. 5,339,036 to Clark et al. teaches a MWD resistivity device in which button electrodes are mounted on a stabilizer blade. The device of Clark is primarily designed for use with WBM and requires that the button electrodes be in close contact with the formation. In a MWD tool, this results in rapid wearing away of the electrodes, necessitating frequent replacement.

U.S. Pat. No. 6,714,014 to Evans et al. having the same assignee as the present application and the contents of which are fully incorporated herein by reference, teaches an apparatus and method based on the use of high frequency measurements for injecting measure currents into the formation. One embodiment of the device and method taught in the Evans '014 patent uses a carrier frequency that is sufficiently high to capacitively couple the measure electrodes to the formation through the nonconducting mud. By modulating the carrier current at a frequency used in prior art resistivity imaging devices, it is possible to get measurements of formation resistivity with relatively minor changes in the hardware of prior art resistivity devices, the main modification being a modulator for producing the measure currents demodulator for demodulation of the measure currents.

U.S. Pat. No. 6,600,321 to Evans, having the same assignee as the present application and the contents of which are fully incorporated herein by reference, discloses a method for obtaining a resistivity image of an earth formation penetrated by the borehole. The apparatus includes at least one measure electrode that injects a measure current into the formation. Due to the high frequency of the current, an electrical circuit is complete when the borehole is filled with a non-conductive fluid through a capacitive gap between the electrode and the formation. A guard potential is provided to maintain focusing of the current. The modulation of the measure current and the demodulation of the output of the current measuring circuit helps to reduce the cross-talk between them. Amplitude modulation reverse amplitude modulation, frequency modulation or phase modulation may be used.

U.S. Pat. No. 6,173,793 B1, issued to Thompson et al. discloses an apparatus and method for obtaining information about a formation using sensors on a substantially non-rotating pads attached to a rotating housing that is part of the drilling assembly. The pads make contact with the formation. The sensors may be density, NMR, resistivity, sonic, or electromagnetic. The NMR sensors may use a static magnetic field that can be either radial or longitudinal in direction. The resistivity sensors may involve direct measurement of leakage current or may rely on induction methods. In an alternate arrangement, the sensors rotate with the drill bit. A downhole microprocessor analyzes the data to improve signal-to-noise ratio and to reduce redundancy in the acquired data. Depth information may be telemetered from an uphole controller to facilitate the process.

A potential drawback of propagation resistivity tools and induction tools is the resolution that may be obtained—in effect, the resolution is limited by the spacing between the transmitter and receiver. Galvanic measurements, while having higher resolution, may be problematic in MWD applications with oil based mud. Some kind of capacitive coupling is needed, and the measurements are affected by the standoff between the tool and the borehole wall. A need exists for obtaining electrical measurements in a robust MWD logging device that obtains higher resolution and has azimuthal recording capabilities. Such a device should preferably be simple and be able to function with oil based muds. The present invention fulfills this need.

### SUMMARY OF THE INVENTION

One embodiment of the invention is an apparatus for use in a borehole in an earth formation. The apparatus includes a coupling device which couples a power source to an antenna which transmits an electromagnetic signal into the borehole. A processor determines from the transmitted electromagnetic signal and an electromagnetic signal reflected from a wall of the borehole a parameter of the earth formation. The parameter may be a resistivity and/or a conductivity. The coupling device may be a directional coupler. The antenna may have a circular shape or a rectangular shape. The apparatus may include a reactive element that compensates for effects of a reactance of the antenna. The reactive element may be a capacitor between the coupling device and the antenna. The coupling device may be part of a bottomhole assembly (BHA) conveyed on a drilling tubular into the borehole, in which case the processor may make a determination of the parameter during continued rotation of the BHA. An orientation sensor may be part of the BHA. If an orientation sensor is used, the processor may produce a resistivity image of the borehole wall. The borehole may have an oil based mud within.

Another embodiment of the invention is method of determining a parameter of interest of an earth formation. A power source is coupled to an antenna which transmits an electromagnetic signal into the borehole. The parameter of interest is determined from the transmitted electromagnetic signal and an electromagnetic signal reflected from a wall of the borehole. The parameter of interest may be a resistivity and/or a conductivity. The coupling the power source to the antenna may use a directional coupler. A reactive element may be used to compensate for effects of a reactance of the antenna. The reactive element may be a capacitor between the antenna and the coupler. The coupling device may be conveyed into the borehole on a bottomhole assembly on a drilling tubular. The parameter of interest may be determined during continued rotation of the bottomhole assembly. Determination of the parameter of interest may be based on using a real part of an impedance of the antenna.

Another embodiment of the invention is a computer readable medium for analyzing data from a resistivity measuring device conveyed in a borehole in an earth formation. The resistivity device includes an antenna that propagates an electromagnetic signal into the formation and circuitry that provides an output signal indicative of a reflectivity of a wall of the borehole. The medium includes instructions that enable determination of a resistivity parameter of the earth formation from the output signal. The medium may be a ROM, an EPROM, an EAROM, a Flash Memory, and/or an Optical disk.

### BRIEF DESCRIPTION OF THE DRAWINGS

The present invention may be best understood by reference to the following figures in which like numerals refer to like elements.

FIG. 1 (Prior Art) illustrates a measurement-while-drilling (MWD) logging device that is suitable for use with the present invention;

FIG. 2 is an exemplary configuration of the various components of a resistivity measuring sensor sub;

FIG. 3 illustrates a setup of a loop antenna according to the present invention;

FIG. 4 is an equivalent circuit diagram of a downhole antenna coupled to a directional coupler;

FIG. 5 is a Smith diagram showing the sensitivity of the configuration of FIG. 4 to formation resistivity;

FIG. 6 is an equivalent circuit diagram of an embodiment of the present invention using a downhole antenna coupled to a directional coupler;

FIG. 7 is a Smith diagram showing the sensitivity of the configuration of FIG. 6 to formation resistivity; and

FIG. 8 is an exemplary chart showing the relation between formation conductance and the determined antenna impedance.

### DETAILED DESCRIPTION OF THE INVENTION

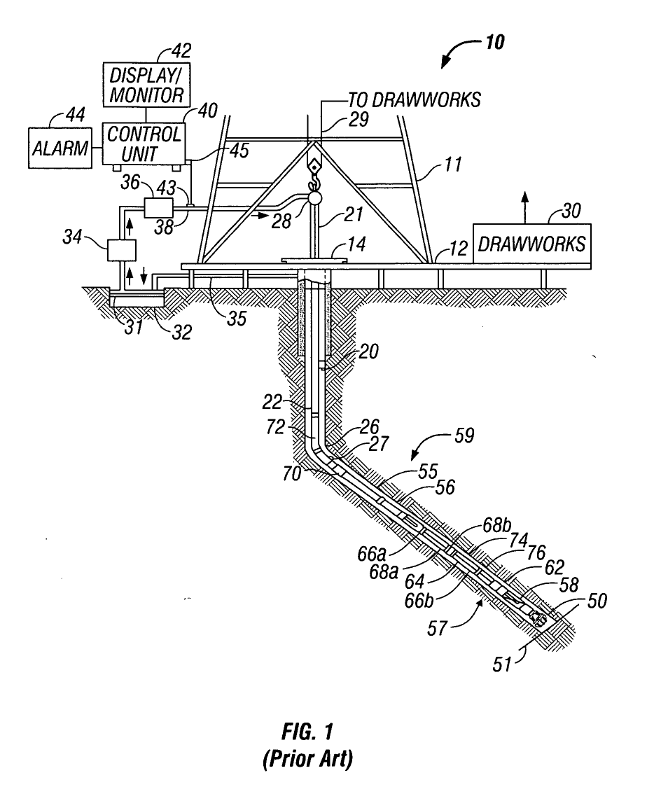

FIG. 1 shows a schematic diagram of a drilling system 10 having a downhole assembly containing an acoustic sensor system and the surface devices according to one embodiment of present invention. As shown, the system 10 includes a conventional derrick 11 erected on a derrick floor 12 which supports a rotary table 14 that is rotated by a prime mover (not shown) at a desired rotational speed. A drill string 20 that includes a drill pipe section 22 extends downward from the rotary table 14 into a borehole 26. A drill bit 50 attached to the drill string downhole end disintegrates the geological formations when it is rotated. The drill string 20 is coupled to a drawworks 30 via a kelly joint 21, swivel 28 and line 29 through a system of pulleys 27. During the drilling operations, the drawworks 30 is operated to control the weight on bit and the rate of penetration of the drill string 20 into the borehole 26. The operation of the drawworks is well known in the art and is thus not described in detail herein.

During drilling operations a suitable drilling fluid (commonly referred to in the art as “mud”) 31 from a mud pit 32 is circulated under pressure through the drill string 20 by a mud pump 34. The drilling fluid 31 passes from the mud pump 34 into the drill string 20 via a desurger 36, fluid line 38 and the kelly joint 21. The drilling fluid is discharged at the borehole bottom 51 through an opening in the drill bit 50. The drilling fluid circulates uphole through the annular space 27 between the drill string 20 and the borehole 26 and is discharged into the mud pit 32 via a return line 35. Preferably, a variety of sensors (not shown) are appropriately deployed on the surface according to known methods in the art to provide information about various drilling-related parameters, such as fluid flow rate, weight on bit, hook load, etc.

A surface control unit 40 receives signals from the downhole sensors and devices via a sensor 43 placed in the fluid line 38 and processes such signals according to programmed instructions provided to the surface control unit. The surface control unit displays desired drilling parameters and other information on a display/monitor 42 which information is utilized by an operator to control the drilling operations. The surface control unit 40 contains a computer, memory for storing data, data recorder and other peripherals. The surface control unit 40 also includes models and processes data according to programmed instructions and responds to user commands entered through a suitable means, such as a keyboard. The control unit 40 is preferably adapted to activate alarms 44 when certain unsafe or undesirable operating conditions occur.

A drill motor or mud motor 55 coupled to the drill bit 50 via a drive shaft (not shown) disposed in a bearing assembly 57 rotates the drill bit 50 when the drilling fluid 31 is passed through the mud motor 55 under pressure. The bearing assembly 57 supports the radial and axial forces of the drill bit, the downthrust of the drill motor and the reactive upward loading from the applied weight on bit. A stabilizer 58 coupled to the bearing assembly 57 acts as a centralizer for the lowermost portion of the mud motor assembly.

In one embodiment of the system of present invention, the downhole subassembly 59 (also referred to as the bottomhole assembly or “BHA”) which contains the various sensors and MWD devices to provide information about the formation and downhole drilling parameters and the mud motor, is coupled between the drill bit 50 and the drill pipe 22. The downhole assembly 59 preferably is modular in construction, in that the various devices are interconnected sections so that the individual sections may be replaced when desired.

Still referring back to FIG. 1, the BHA may also contain sensors and devices in addition to the above-described sensors. Such devices include a device for measuring the formation resistivity near the drill bit, a gamma ray device for measuring the formation gamma ray intensity and devices for determining the inclination and azimuth of the drill string. The formation resistivity measuring device 64 may be coupled above the lower kick-off subassembly 62 that provides signals, from which resistivity of the formation near or in front of the drill bit 50 is determined. A dual propagation resistivity device (“DPR”) having one or more pairs of transmitting antennae 66a and 66b spaced from one or more pairs of receiving antennae 68a and 68b may be used. Magnetic dipoles are employed which operate in the medium frequency and lower high frequency spectrum. In operation, the transmitted electromagnetic waves are perturbed as they propagate through the formation surrounding the resistivity device 64. The receiving antennae 68a and 68b detect the perturbed waves. Formation resistivity is derived from the phase and/or amplitude of the detected signals. The detected signals are processed by a downhole circuit that is preferably placed in a housing 70 above the mud motor 55 and transmitted to the surface control unit 40 using a suitable telemetry system 72. Determination of formation resistivity from amplitude and phase measurements is well known in prior art. U.S. Pat. No. 5,811,973 to Meyer having the same assignee as the present invention and the contents of which are fully incorporated herein by reference, further teaches the determination of resistivity of the connate formation fluid, the dielectric constant of the dry rock matrix, and the water filled porosity of the formation. Such determinations may also be made with the present invention using the methods taught by Meyer.

The inclinometer 74 and gamma ray device 76 are suitably placed along the resistivity measuring device 64 for respectively determining the inclination of the portion of the drill string near the drill bit 50 and the formation gamma ray intensity. Any suitable inclinometer and gamma ray device, however, may be utilized for the purposes of this invention. In addition, an azimuth device (not shown), such as a magnetometer or a gyroscopic device, may be utilized to determine the drill string azimuth. Such devices are known in the art and are, thus, not described in detail herein. In the above-described configuration, the mud motor 55 transfers power to the drill bit 50 via one or more hollow shafts that run through the resistivity measuring device 64. The hollow shaft enables the drilling fluid to pass from the mud motor 55 to the drill bit 50. In an alternate embodiment of the drill string 20, the mud motor 55 may be coupled below resistivity measuring device 64 or at any other suitable place.

The drill string contains a modular sensor assembly, a motor assembly and kick-off subs. In a preferred embodiment, the sensor assembly includes a resistivity device, gamma ray device, and inclinometer. A processor (not shown) is located downhole for processing the data. Due to the large amount of data that are obtained and processed downhole, a memory device having adequate capacity is necessary.

The above-noted devices transmit data to the downhole telemetry system 72, which in turn transmits the received data uphole to the surface control unit 40. The downhole telemetry also receives signals and data from the uphole control unit 40 and transmits such received signals and data to the appropriate downhole devices. The present invention preferably utilizes a mud pulse telemetry technique to communicate data from downhole sensors and devices during drilling operations. A transducer 43 placed in the mud supply line 38 detects the mud pulses responsive to the data transmitted by the downhole telemetry 72. Transducer 43 generates electrical signals in response to the mud pressure variations and transmits such signals via a conductor 45 to the surface control unit 40. Other telemetry techniques such electromagnetic and acoustic techniques or any other suitable technique may be utilized for the purposes of this invention. The drilling assembly also includes a directional sensor. Without limiting the scope of the invention, the directional sensor can be a magnetometer or of the inertial type.

In one embodiment of the invention, a drilling sensor module 59 is placed near the drill bit 50. The drilling sensor module contains sensors, circuitry and processing software and algorithms relating to the dynamic drilling parameters. Such parameters preferably include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

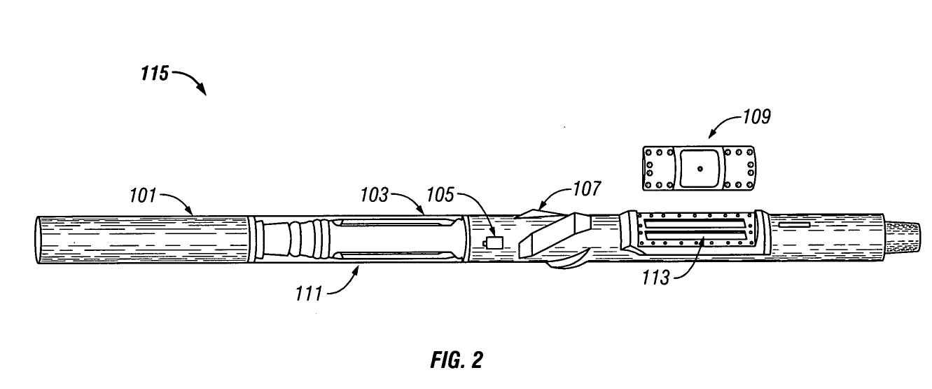

Turning now to FIG. 2, an exemplary configuration of the various components of an exemplary resistivity measuring sensor sub are shown. At the upper end, a modular cross-over sub 101 is provided. The power and processing electronics are indicated by 103. The sub is provided with a stabilizer 107 and a data dump port may be provided at 105. A resistivity sensor (discussed further below) is provided at 109 with the sensor and measuring electronics at 113. Modular connections 115 are provided at both ends of the sub that enable the sub to be part of the bottom hole drilling assembly. An orientation sensor 111 is provided for measuring the toolface angle of the sensor assembly during continued rotation. Different types of orientation sensors may be used, including magnetometers, accelerometers, or gyroscopes. Use of such devices for the determination of the toolface angle is known in the art and is not discussed further herein.

The stabilizer shown at 107 serves several important functions. Like conventional stabilizers, one function is to reduce oscillations and vibrations of the sensor assembly. However, in the context of the present invention, it also serves another important function, viz, centralizing the portion of the bottom hole assembly (BHA) including a sensor assembly, and also maintaining the sensors with a specified standoff from the borehole wall. This is not visible in FIG. 2, but the outer diameter of the stabilizer is greater than the outer diameter of the portion of the BHA including the resistivity sensor. As a result of this difference in diameter, the resistivity sensor is maintained with a standoff from the borehole wall during continued rotation of the drillstring.

In an alternate embodiment of the invention (not shown), the resistivity sensor may be mounted on the stabilizer. This brings the sensor closer to the borehole wall. Individual resistivity sensor may be mounted on a plurality of stabilizers. With such a plurality of stabilizers, the likelihood that at least one sensor will be in touch with the borehole wall of a rugose borehole is increased. An appropriate selection criterion may then be used to select “good” measurements and discard “bad” measurements.

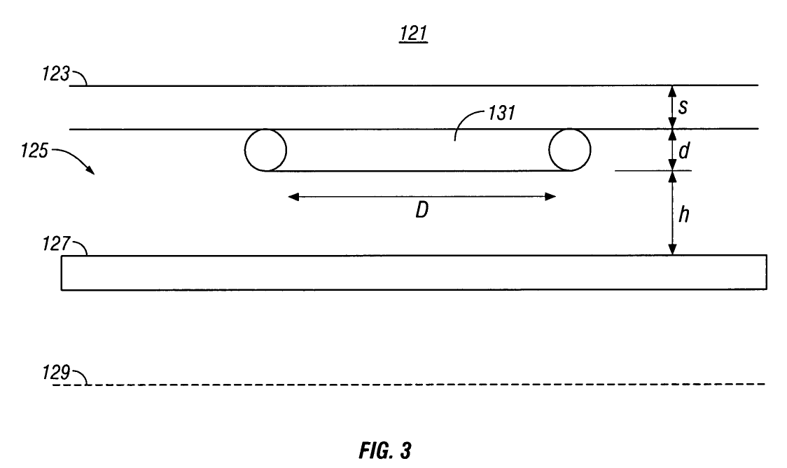

The principles of the present invention are first illustrated using a single loop antenna for the sensor 109. This is illustrated schematically in the cross-section of FIG. 3. The earth formation is denoted by 121. The BHA axis is denoted by 129. A loop antenna 131 having a diameter D is positioned within a dielectric medium 125 at a distance h from the drill collar 127. In the annular space of thickness s between the dielectric medium 125 and the borehole wall 123 is drilling mud.

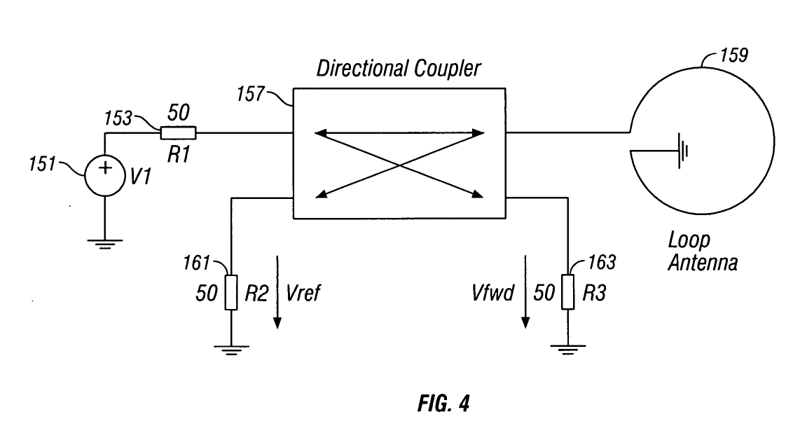

The earth formation typically has a resistivity between 0.2 Ω-m and 2000 Ω-m and a relative permittivity εᵣ between 1 and 100. The values used for the examples are for exemplary purposes only and not to be construed to limit the scope of the invention. The borehole mud is assumed, without being a limitation, to be non conductive (σ=0) with a relative permittivity εᵣ of 1, while the dielectric in which the antenna is embedded has a conductivity substantially equal to zero and a permittivity εᵣ between 3 and 6. These values are for exemplary purposes only and not to be construed as a limitation to the invention. The antenna ring is not completely closed but is connected to ground on one side of a center gap to the outer port of a directional coupler, discussed below with reference to FIG. 4.

Referring now to FIG. 4, the equivalent circuit for the sensor-earth system of FIG. 3 is illustrated. A directional coupler 157 is used to couple the antenna 159 to the power source 151 through its source impedance R1 153. Directional couplers are general purpose tools used in RF and microwave signal routing for isolating, separating or combining signals. They find use in a variety of measurement applications including power monitoring, source leveling, isolation of signal sources, and transmission and reflection measurements. They have not been hitherto used in borehole applications. As discussed below, they may be used for resistivity imaging of borehole walls. Specifically, with the configuration shown, the antenna impedance as determined by the configuration of FIG. 4 is indicative of the resistivity of the earth formation.

The circular loop antenna, typically made out of copper wire, has an inner diameter D, a wire diameter d and is mounted at a distance h above a metal surface (preferably copper). The antenna ring is not completely closed, but connected to ground on one side of a center gap and to the output port of a directional coupler on the other side as shown in FIG. 4.

A power source 151 is connected to the input port 157 of the directional coupler and the forward (V_{fwd}) and reflected (V_{ref}) voltages are measured in magnitude and phase (complex measurements) across resistors 161 and 163. The reference impedance of the directional coupler is Z₀ (typically 50 Ω). From the above (complex) measurements the reflection coefficient Γ_{L} can now be computed:

$${Γ}_{L} = \frac{{V}_{ref}}{{V}_{fwd}} = \frac{Z - {Z}_{0}}{Z + {Z}_{0}} \qquad ( 1 )$$

with Z being the loop antenna impedance. Z can thus be expressed as

$$Z = {Z}_{0} \times \frac{1 + {Γ}_{L}}{1 - {Γ}_{L}} . \qquad ( 2 )$$

In the present invention, the reflection coefficient is determined by a processor frothe values of V_{ref} and V_{fwd}. Note that this is a complex quantity, having both a magnitude and a phase (or, equivalently, real and imaginary part). The real part of the loop antenna impedance is formation resistivity dependent. We next examine the sensitivity of the measured reflection coefficient with the configuration of FIG. 4.

The reflection coefficient r is conveniently displayed in a Smith chart, which maps the complex impedance plain onto the complex reflection coefficient plain. To digress briefly, the reflection coefficient r can be expressed as:

$${Γ}_{L} = \frac{{V}_{ref}}{{V}_{fwd}} = \frac{Z - {Z}_{0}}{Z + {Z}_{0}} = {Γ}_{r} + j {Γ}_{i} . \qquad ( 3 )$$

We define a normalized impedance z as

$$z = \frac{{Z}_{L}}{{Z}_{0}} = r + j x . \qquad ( 4 )$$

The Smith diagram is chart that has as its background two intersecting sets of curves. One set of circles is defined by

$${( {Γ}_{r} - \frac{r}{r + 1} )}^{2} + {Γ}_{i}^{2} = {( \frac{1}{1 + r} )}^{2} \qquad ( 5 )$$

and the other set of circles is defined by

$${( {Γ}_{r} - 1 )}^{2} + {( {Γ}_{i} - \frac{1}{x} )}^{2} = \frac{1}{{x}^{2}} . \qquad ( 6 )$$

Based on the intersections of the two sets of circles, it is possible to determine the real and imaginary parts of the impedance from a measured reflection coefficient.

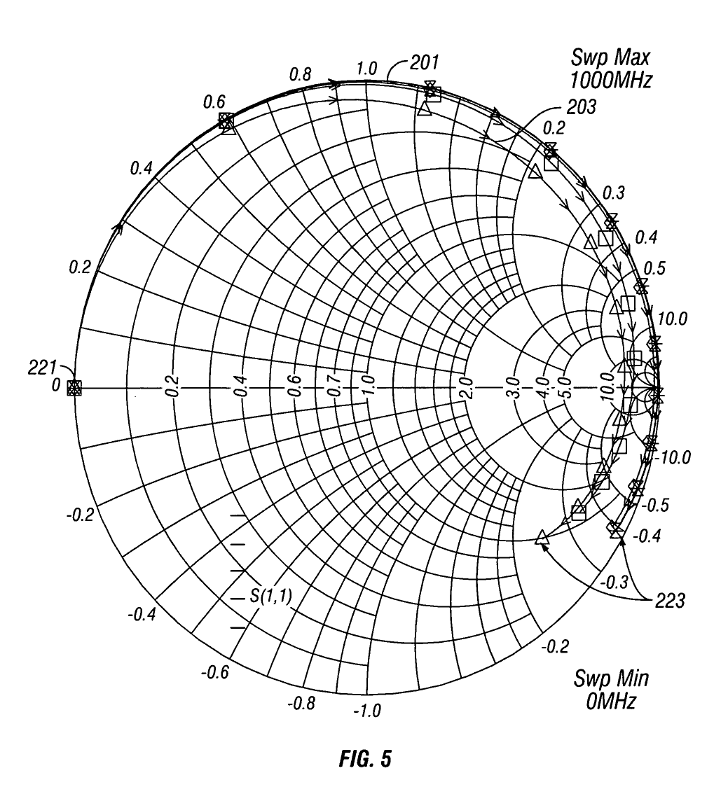

The response curves for the circuit of FIG. 4 are shown in FIG. 5. Five different curves are shown, of which only two are labeled to simplify the illustration. The results correspond to a formation of εᵣ=10 and ρ=0.2, 2, 20, 200 and 2000 Ω-m. The mud thickness is 0.5 mm. The loop antenna has a D of 25 mm, d of 1 mm and h of 10 mm. The curve 201 corresponds to a formation resistivity of 0.2 Ω-m while the curve 203 corresponds to a formation resistivity of 2000 Ω-m. The curves correspond to a frequency of 0 MHz (221) and 1000 MHz (223) in steps of 100 MHz. As can be seen in FIG. 5, even at higher frequencies (>200 MHz), the reflection coefficient loci are close to the edge of the Smith chart and thus the resistances (i.e. the real parts of Z) are not very well resolved.

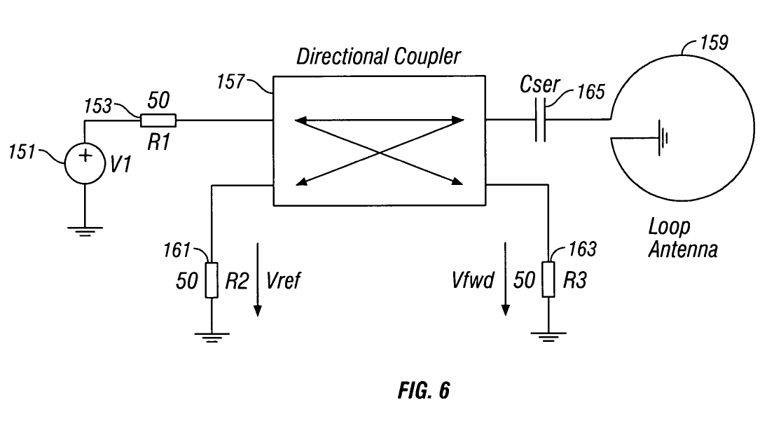

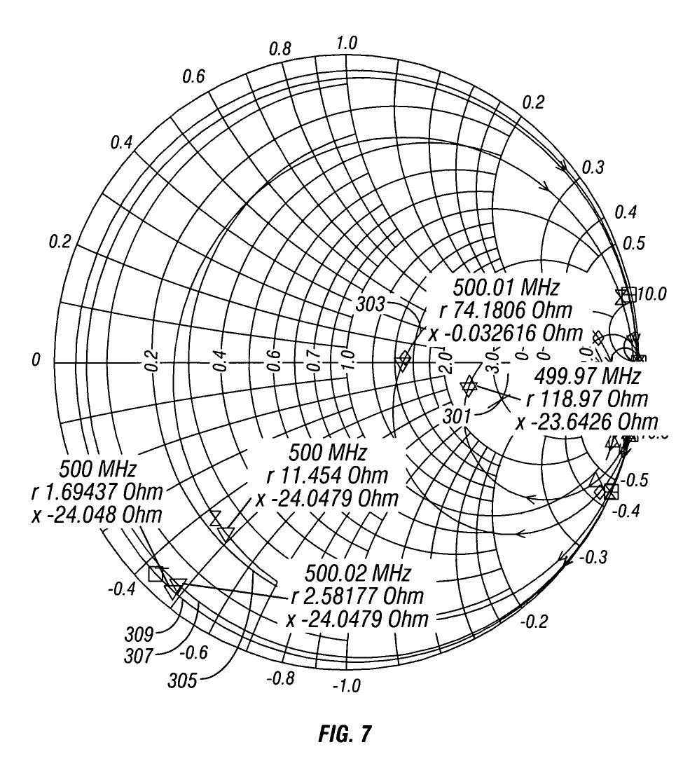

Part of the invention is the recognition that the relative insensitivity of the circuit configuration of FIG. 4 to formation resistivity is due to the antenna inductance. By the addition of a series capacitor (as shown by 165 in FIG. 6), the sensitivity to formation resistivity is greatly increased. This is shown in FIG. 7 where five curves labeled 301, 303, 305, 307 and 309 are shown. These correspond to resistivities of 0.2 Ω-m, 2 Ω-m, 20 Ω-m, 200 Ω-m and 2000 Ω-m. The points corresponding to approximately 500 MHz are specifically show in FIG. 7 and labeled with the corresponding (real) resistivity and the reactive impedance. The results are summarized in Table 1.

TABLE 1
Real part of antenna impedance

| | Real part of antenna | Real part of antenna |
|---|---|---|
| Formation resistivity [Ω-m] | impedance [Ω] | admittance [S] |
| 0.2 | 118.97 | 0.008405 |
| 2 | 74.18 | 0.13481 |
| 20 | 11.45 | 0.87336 |
| 200 | 2.59 | 0.3861 |
| 2000 | 1.69 | 0.591716 |

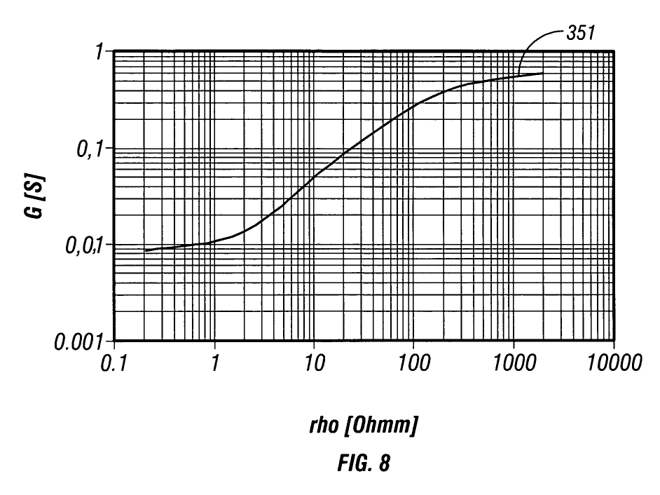

The results are displayed graphically in FIG. 8 where the antenna conductance (real part of antenna admittance) is plotted against the formation resistivity. This clearly demonstrates that with appropriate calibration, the antenna impedance (or conductance) as determined from the reflectivity measurements is indicative of the formation resistivity. It should be noted that the use of the Smith chart is for illustrative purposes only and is not a limitation of the invention. The use of the Smith chart in FIGS. 5 and 7 is a graphical depiction of the principles on which the present invention is based. The actual processing is done by a suitable processor. The processing may be done downhole, or may be done at the surface with data stored downhole on a suitable memory device and recovered when the drillstring is tripped out of the borehole.

The measurements may be made during continued rotation of the BHA. A suitable orientation sensor such as a magnetometer makes measurements indicative of a toolface angle of the BHA. The resistivity measurements may then be combined with the corresponding angle measurements to obtain a resistivity image of the borehole wall.

Problems may be encountered in processing of signals at the frequencies discussed above due to limitations imposed by the analog to digital converters (A/D) used for sampling the RF signals. Even for a 300 MHz signal, this requires a sampling rate of at least 6×10⁸ samples per second. In order to avoid the complexity of an analog to digital converter capable of operating at such high sample rates, the data are deliberately undersampled. Such undersampling is disclosed, for example, in EP1315285 to Sorrels et al. and in U.S. patent application Ser. No. 10/616,857 of Chemali et al, having the same assignee as the present invention and the contents of which are fully incorporated herein by reference. By such undersampling, the necessary amplitude and phase information about the signals can be recovered without having high sampling rate A/D converters.

The processing of the data may be accomplished by a downhole processor. Implicit in the control and processing of the data is the use of a computer program implemented on a suitable machine readable medium that enables the processor to perform the control and processing. The machine readable medium may include ROMs, EPROMs, EAROMs, Flash Memories and Optical disks.

While the foregoing disclosure is directed to the preferred embodiments of the invention, various modifications will be apparent to those skilled in the art. It is intended that all such variations within the scope and spirit of the appended claims be embraced by the foregoing disclosure.

What is claimed is:

1. An apparatus for use in a borehole in an earth formation, the apparatus comprising:
(a) a coupling device coupling a power source to an antenna which transmits an electromagnetic signal into the borehole;
(b) a processor which determines from the transmitted electromagnetic signal and an electromagnetic signal reflected from a wall of the borehole a parameter of interest of the earth formation.

2. The apparatus of claim 1 wherein the parameter is selected from the group consisting of (i) a resistivity, and (ii) a conductivity.

3. The apparatus of claim 1 wherein the coupling device comprises a directional coupler.

4. The apparatus of claim 1 wherein the antenna comprises a shape that is selected from the group consisting of (i) a circular shape, and, (ii) a rectangular shape.

5. The apparatus of claim 1 further comprising a reactive element that compensates for effects of a reactance of the antenna.

6. The apparatus of claim 5 wherein the reactive element comprises a capacitor between the coupling device and the antenna.

7. The apparatus of claim 1 wherein the coupling device is part of a bottomhole assembly (BHA) conveyed on a drilling tubular into the borehole.

8. The apparatus of claim 7 wherein the processor makes a determination of the parameter during continued rotation of the BHA.

9. The apparatus of claim 8 further comprising an orientation sensor on the BHA; wherein the processor further produces a parameter image of the borehole using an output of the orientation sensor.

10. The apparatus of claim 1 wherein the power source has an operating frequency between about 1 MHz and 1000 Mhz.

11. The apparatus of claim 7 wherein an oil based mud is present between the BHA and a wall of the borehole.

12. The apparatus of claim 1 wherein the processor determines the parameter of interest based at least in part on a real part of an impedance of the antenna.

13. A method of determining a parameter of interest of an earth formation, the method comprising:
(a) coupling a power source to an antenna which transmits an electromagnetic signal into the borehole;
(b) determining from the transmitted electromagnetic signal and an electromagnetic signal reflected from a wall of the borehole the parameter of interest of the earth formation.

14. The method of claim 13 wherein the parameter of interest is selected from the group consisting of (i) a resistivity, and (ii) a conductivity.

15. The method of claim 14 further comprising coupling the power source to the antenna using a directional coupler.

16. The method of claim 13 further selecting and antenna with a shape that is selected from the group consisting of (i) a circular shape, and, (ii) a rectangular shape.

17. The method of claim 13 further comprising using a reactive element to compensate for effects of a reactance of the antenna.

18. The method of claim 17 wherein the reactive element comprises a capacitor positioned between the antenna and the directional coupler.

19. The method of claim 13 further comprising conveying a bottomhole assembly (BHA) including the coupling device into the borehole.

20. The method of claim 19 further comprising determining the parameter of interest during continued rotation of the BHA.

21. The method of claim 20 further comprising making measurements of an orientation of the BHA during the continued rotation and producing a parameter image of the borehole

22. The method of claim 23 further comprising operating the power source at a frequency between about 1 MHz and 1000 Mhz.

23. The method of claim 13 wherein determining the parameter of interest further comprises using a real part of an impedance of the antenna.

24. A computer readable medium for analyzing data from a resistivity measuring device conveyed in a borehole in an earth formation, the resistivity device comprising:
(a) an antenna that propagates an electromagnetic signal into the formation; and
(b) circuitry that provides an output signal indicative of a reflectivity of a wall of the borehole;
the medium comprising instructions that enable determination of a resistivity parameter of the earth formation from the output signal.

25. The medium of claim 24 selected from the group consisting of: (i) a ROM, (ii) an EPROM, (iii) an EAROM, (iv) a Flash Memory, and (v) an Optical disk.
